(19) United States
(12) Patent Application Publication
(10) Pub. No.: US 2007/0177378 A1
(43) Pub. Date: Aug. 2, 2007

(54) Full color flashlight with high power LED

(76) Inventors: Ting-Feng Wu, Kaohsiung City (TW); Jun-Hong Lin, Pingtung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/344,254

(22) Filed: Feb. 1, 2006

(51) Int. Cl. F21L 4/02

(52) U.S. Cl. 362/184; 362/205; 362/206

(57) ABSTRACT

The present invention discloses a full color flashlight with high power LEDs. The flashlight is primarily composed of a full color LED module having LED chip set of different wavelengths, a control-circuit module, a function switch, batteries, and a barrel body. By controlling the LED chip set of different wavelengths through the control-circuit module, light beams of various colors can be emitted and uniformly mixed. The flashlight further comprises a function switch for changing the color of light and/or switching operation modes between a fast flash mode, a slow flash mode, a brightness control mode and un-lighting. Accordingly, the full color flashlight can be employed in different environments, for example, yellow or light blue light can be used at night to prevent the eyes from dazzling, and red flash can be as warning signal during traffic events; in conclusion, the present invention can be elaborate in the day-to-day life.

### BACKGROUND OF THE INVENTION

1. Field of the Invention

The present invention relates to a full color flashlight with high power LEDs, which particularly comprises a control-circuit module and a full color LED module having LED chip sets of different wavelengths, and therefore can perform light of various colors. The LED flashlight of the present invention also provides a function switch for changing color and/or brightness of light, or switching flash modes, so as to be suitable for different situations.

2. Related Prior Arts

The conventional LED flashlights can only emit light of a single color, for example, white, red, blue, green or yellow, therefore, consumers have to purchase more than one flashlights to deal with different situations and purposes. It waste money and is inconvenient for the user during operation.

Better than the monochromatic flashlights, dual color LED flashlights may perform two colors, for example, white and green, or white and blue. However, it is still not versatile enough for practical use.

To solve such problems, tricolor LED flashlights was developed, which typically comprise red and green and blue (RGB) three colors. Unfortunately, the conventional tricolor flashlights could merely perform three colors individually, but cannot generate other uniform colors by mixing the light beams; therefore, conventional tricolor flashlights still has two disadvantages as follow:

Disadvantage 1: Practical white light is not available. FIG. 8 shows a traditional tricolor LED flashlight which is composed of six red LEDs (81), six green LEDs (82) and six blue LEDs (83), so that could perform three colors individually. Since such flashlight lacks a regulating mechanism for uniformly mixing light, while it wants to perform white light, all LEDs have to be lit simultaneously, and therefore spots of red, green and blue light will be apparently observed, not the typical white light we want.

Disadvantages 2: In addition to white light, uniform light of other colors also could not be achieved without proper regulating mechanism, for example, pink, purple, or amber. Therefore, the mixed color is still displayed as spots of red, green and blue light, not the typical pink, purple, or amber color we want.

Hence, the conventional tricolor LED flashlight can normally perform three colors only. Other colors will not be available as the problem of mixing light is not effectively.

The present invention thus provides a full color flashlight, whereby the user can use it in different situations and purposes without carrying other flashlights. Moreover, the full color LED flashlight not only can be operated in different modes to perform various colors, but also could be operated such as fast or slow flash. Therefore, consumers only buy one flashlight for adapting any purpose. In addition, the full color flashlight of the present invention also performs superior effect in mixing light. By uniformly mixing the light beams, white light and other versatile colors, such as pink, cyanic, orange, purple or amber, etc., that can be achieved as well mixed.

### SUMMARY OF THE INVENTION

The objective of full color flashlight with high power LEDs, that was invented for solving problems which mentioned before.

In the present invention, two or more high power LED bare chips of different wavelengths are preferably used, for example, high power three color LED chips of red and green and blue or yellow and green and blue. Compared with the traditional tricolor LED flashlights, the present invention has three merits as follows:
1. The size is reduced by using the high power LED bare chips. High power LED bare chips are used of this invention. Compared with traditional LED chips, its power is higher than traditional one. For example, 1 watt of high power LED chips are used in present invention, but the traditional chips only contain 0.05 watt, therefore, the present inventions only need one high power LED chip that can illuminate as twenty traditional LED chips, and thus the size of the present invention is effectively reduced.
2. LED chips are mounted on the same base. Because of the size of high power LED chips are small, so they could be mounted on the same base and also arranged very closely. Therefore, while emitting lights simultaneously, the result of these small LED chips are looked like a single light source. By such arrangement, people will see the mixed light performing only in one color, and thus purer white light or light of other colors can be achieved.
3. Adding light mixer. Additional compositions such as the photodiffuser as light mixer, which can be added in the transparent glue in front of the LED bare chips for protecting the LED bare chips. The photodiffuser can diffuse the light beams emitted from the red, green, and blue (RGB) or yellow, green and blue (YGB) LED chips, whereby the light beams will travel randomly in arbitrary directions and be mixed white light or other color lights uniformly and cannot be distinguished by people.

According to the present invention, that could be emitted various colors, but also uniform light of different colors, for example, white light, purple light, pink light, orange light, cyanic light, amber light, etc. By operating the function switch, the user can conveniently change color and optically switch different modes such as fast or slow flash. Therefore, it is suitable for any situations, for example, yellow or light blue light can be used at night to prevent the eyes from dazzling, and red flash can be a warning signal during traffic events, so this invention can be elaborate in the life.

### BRIEF DESCRIPTION OF THE DRAWINGS

FIG. 1 shows the disassembled flashlight of the first embodiment in accordance with the present invention.

FIG. 2 shows the disassembled flashlight of the second embodiment in accordance with the present invention.

FIG. 3 indicates the connection between the full color LED module and the control-circuit module in detail.

FIG. 4 shows the alternative connection between the full color LED module and the control-circuit module.

FIG. 5 shows the rotational switch.

FIG. 6 shows the convex lens instead of the plate lens of FIGS. 2˜4.

FIG. 7 shows the transparent rod instead of the plate lens of FIGS. 2˜4.

FIG. 8 shows the typical tricolor LED flashlight.

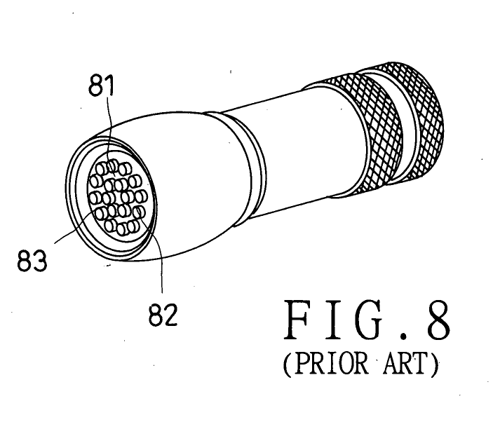

### DETAILED DESCRIPTION OF THE PREFERRED EMBODIMENTS

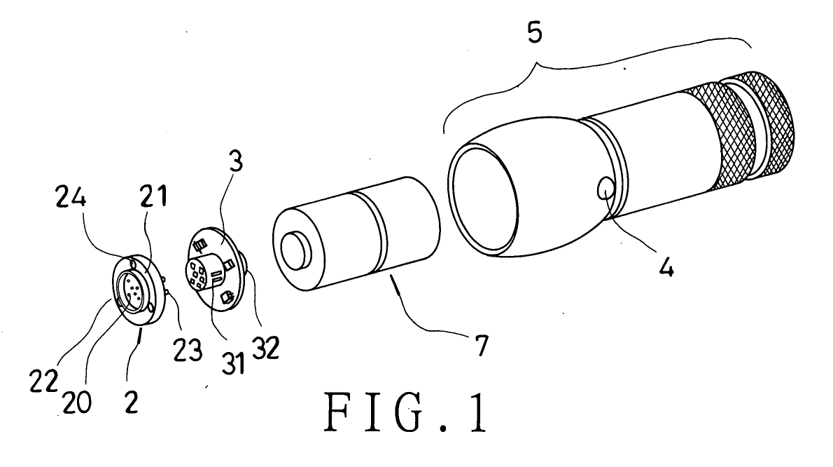

FIG. 1 shows a disassembled flashlight of the first embodiment in accordance with the present invention, in which a full color LED module (2) having LED chip sets of different wavelengths (20), a control-circuit module (3), a function switch (4), a barrel body (5) and batteries (7) are included. The full color LED module (2), the control-circuit module (3) and the batteries (7) are all housed in the barrel body (5).

As shown in FIG. 1, the full color LED module (2) comprises at least two LED chip sets of different wavelengths (20), for example, the red, green and blue (RGB) high power LED chip sets or the yellow, green and blue (YGB) high power LED chip sets. The LED chip sets of different wavelengths (20) are mounted on a DIP base (21) and further covered with a transparent glue (22). Positive and negative electrodes (not shown in figures) of the LED chip sets of different wavelengths (20) are electrically connected with metallic pin (23). In this embodiment, the metallic pin (23) can be properly inserted into corresponding holes within an electrical connector (31) of the control-circuit module (3).

As shown in FIGS. 1˜3, the control-circuit module (3) also provides an electrode terminal (32) typically connected to the positive electrode of one battery (7), and other contact (not shown in figures) is connected to the negative electrode of one battery (7) through the barrel body (5). Through the above circuit, necessary voltage can be supplied to the LED chips and light them. While such typical electrical connection is exemplified in the preferred embodiments, any other circuit suitable for the flashlight can be applied to the present invention without specific limitation.

In general, the function switch (4) is also electrically connected with the control-circuit module (3) to transmit signals thereto. By switching the function switch (4), the control-circuit module (3) will determine which mode is selected and how to light up the LED chip sets of different wavelengths (20) of the full color LED module (2) accordingly. As a result, a full color flashlight with high power LEDs and selective operation modes is achieved.

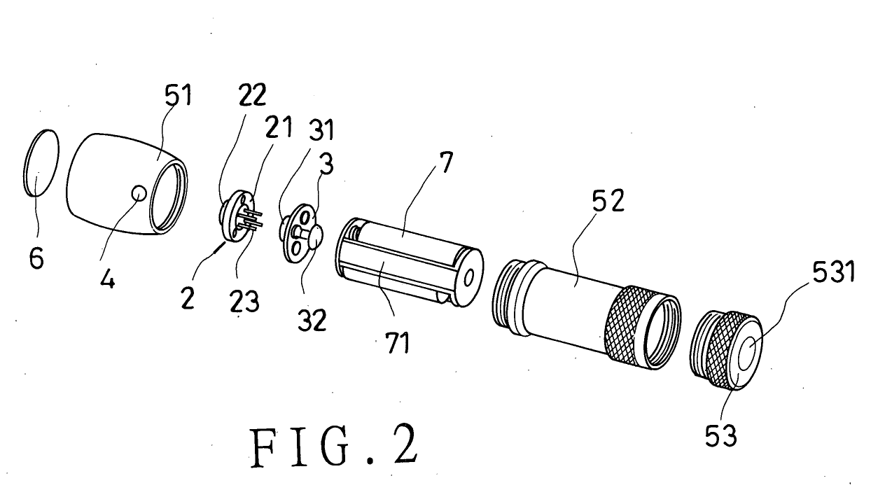

FIG. 2 shows a disassembled LED flashlight of the second embodiment in accordance with the present invention. The flashlight in this embodiment is similar to the first one except the structure of the barrel.

As shown in FIG. 2, the barrel body (5) can be divided into a barrel head (51), a barrel main body (52) and a barrel tail cap (53), so that the barrel body can be easily separated and assembled. In addition, a reflector (not shown in figures) is disposed in the barrel head (51) to concentrate or focus the light beams emitted from the full color LED module (2). Furthermore, a plate lens (6) is installed in the front end of the barrel head (51) to protect elements within the barrel head (51) from impact, dusts and moisture.

In FIG. 2, a power switch (531) is disposed behind the barrel tail cap (53). The power switch can be designed as any proper forms, for example, a push button or a rotary switch. Additionally, the batteries (7) can be pre-installed in a battery holder (71) which is then inserted into the barrel body (5).

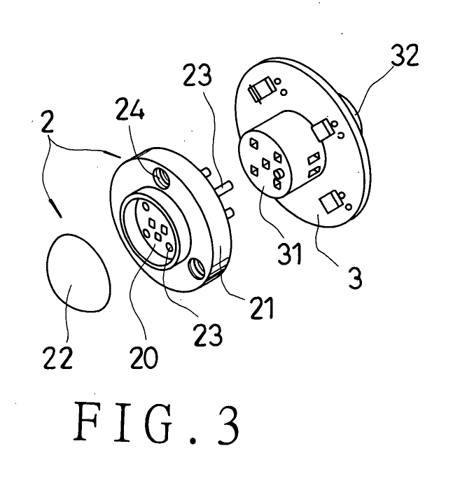

FIG. 3 further indicates connection between the full color LED module (2) and the control-circuit module (3) in detail, in which the DIP (Dual In-line Package) technology is applied. The full color LED module (2) comprises the LED chip sets of different wavelengths (20), the DIP base (21), the transparent glue (22), the metallic pin (23), screwed hole (24), the electrical connector (31) and the electrode terminal (32). The LED chip sets of different wavelengths (20) are mounted on the DIP base (21) and covered with the transparent glue (22); and have the electrodes thereof to be connected with the corresponding metallic pin (23). The metallic pin (23) are further extended from behind the DIP base (21) so as to couple with the electrical connector (31) which is disposed on the front side of the control-circuit module (3). The contact (32) is disposed on the rear side of the control-circuit module (3) for contacting with the battery. The LED chip sets of different wavelengths (20) are preferably composed of two or more chips of different wavelengths, for example, using red, green and blue (RGB) high power LED chip sets, or the yellow. Green and blue (YGB) high power LED chip sets. As the bare chips are small enough to be closely mounted on the DIP base (21), and therefore can perform as a single light source. That is, the light beams emitted from different LED chips are well mixed and can not be distinguished by people. Thus light of purer white or other colors are achieved.

In addition, a photodiffuser (not shown in figures) can be provided in the transparent glue (22), so that the light beams emitted from the LED chips (20) of different colors can be diffused and travel randomly in arbitrary directions. Thereby the light beams can be mixed more uniformly and will be more practical for use. The photodiffuser can be any one or more suitable material, for example, silicone resin, Al₂O₃, MgO, ZnO, TiO₂, MgO and BaO.

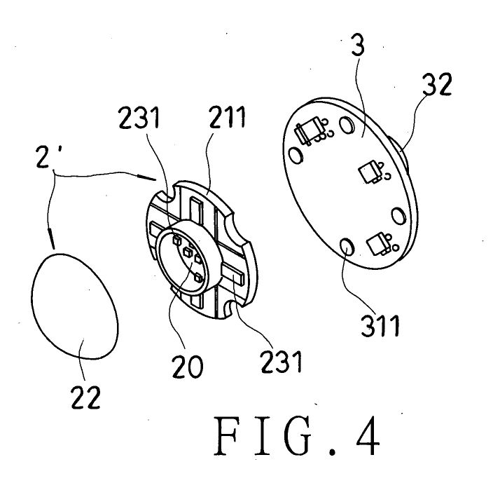

FIG. 4 shows an alternative connection between the full color LED module (2) and the control-circuit module (3), not only DIP (Dual In-line Package) technology is applied (show in the FIG. 3); in which SMD (Surface Mount Device) also can be applied.

The SMD base (211) comprises several metallic pin (231) for electrically connecting with the LED chip sets of different wavelengths (20). The metallic pins (231) are also connected to the electrical connector (311) of the control-circuit module (3). The transparent glue (22) is disposed on the LED chip sets of different wavelengths (20) to develop the full color LED module (2′).

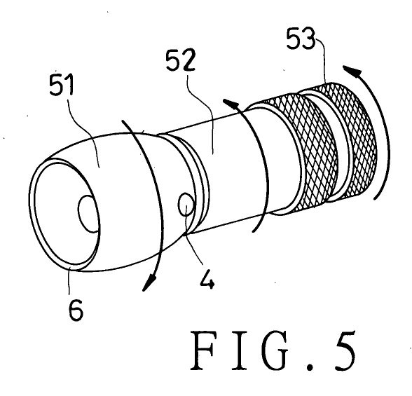

The power switch of the present invention is not restricted to be disposed behind the barrel tail cap (53) as shown in FIG. 2, and can be also arranged at any positions where the user can conveniently operate. The power switch can be even associated with the function switch (4), and designed as other types in addition to a push button. FIG. 5 shows a rotational switch, in which the barrel head (51), the barrel main body (52) or the barrel tail cap (53) can be rotated to a specific position to start the circuit. When not used, the flashlight can be turned off by inversely rotating the barrel head (51), the barrel main body (52) or the barrel tail cap (53).

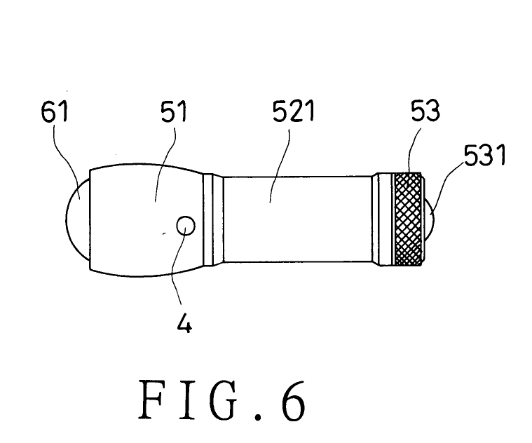

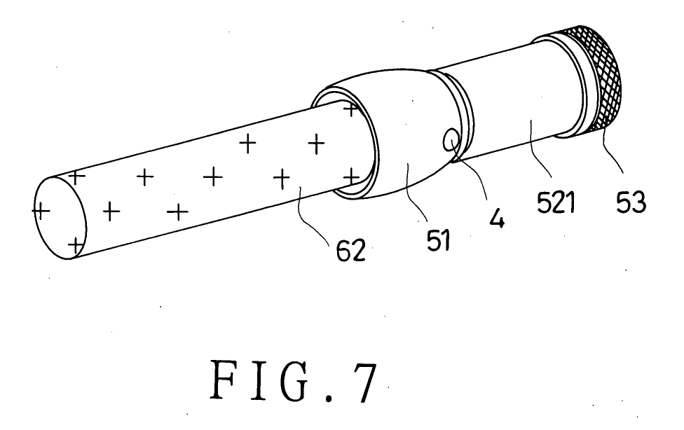

FIGS. 6 and 7 show more types of the flashlights, in which the flat plate lens (6) can be replaced with a convex lens (61), a concave lens (not shown in figures), a transparent rod (62), a hollow transparent tube (not shown in figures), etc. These may allow the user to apply the flashlight in different situations. For example, the concave lens facilitating illumination farther that is suitable for using in the night or mountains, and the transparent rod (62) can be operated flash mode of red light that can serve as a temporary traffic signal baton. All examples as mentioned that can be operated in the day-to-day life by using full color flashlight. The customer can optically select a full color flashlight with proper functions, or change different type of barrel main body (521) instead of the barrel main body (52).

One significant feature of the present invention is the function switch (4), which is disposed behind the barrel body (5) and electrically connected to the control-circuit module (3). By operating the function switch (4), the user may change colors of light, or make the light fast or slow flash, or unilluminated. Preferred operation modes of the function switch (4) in the form of one button are as follows:
1. Change colors of light
   Press the button once to change a light color.
2. Flash mode
   Continuously press the button for 2 seconds to enter the fast flash mode;
   continuously press the button for another 2 seconds to enter the slow flash mode; and
   continuously press the button for 2 seconds again to leave the flash mode.
3. Sleeping mode
   Continuously press the button for 5 seconds to enter the sleeping mode, i.e., unillumination; and
   press the button again to return to the previous lighting state.
4. After flashlight stating in the sleeping mood, the pervious lighting state will be recorded automatically, so while flashlight is operated again, the recorded color of light will be illuminated.

Also, the function switch (4) may comprise one or more operation elements, and can be disposed on any suitable position where the user can conveniently operate it. For the function switch (4) with two buttons (for example, button A and button B), preferred operation modes are as follows:
1. Change colors
   Press the button A once to change a light color.
   2. Flash mode
   Press the button two seconds serially to enter the fast flash mode;
   press the button B once again to enter the slow flash mode; and
   press the button once again to leave the flash mode and back to normal mode.
3. Sleeping mode
   Continuously press the button A or B for 3 seconds to enter the sleeping mode as unillumination; and press the button once again to return to the previous lighting state.
4. After flashlight state in the sleeping mood, the pervious lighting state will be recorded automatically, so while flashlight is operated again, the recorded color of light will be illuminated.
   In the present invention, the batteries (7) are not limited to the dry battery, and can be a lithium cell, an alkaline cell, a rechargeable cell, a mercury cell, etc. All of the batteries that we use in any electric equipment are suitable for full color flashlight with high power LED of this invention.

In the present invention, the full color flashlight not only performs single color, dual color, tricolor or seven colors, buy also can perform light of various colors by controlling current flowing through each of the LED chips. For example, the light beams emitted from the red, green and blue (RGB) LED chip sets can be mixed in specific ratios to perform colors as follows:
1. 70% R+90% G+100% B=white
2. 100% R+0% G+70% B=pink
3. 100% R+80% G+0% B=yellow
4. 60% R+40% G+100% B=purple

Accordingly, colors of the light can be arbitrarily varied by changing the current flowing through the RGB LED chip sets. For example, if the current of the RGB LED chips can be varied with a scale of 1˜100, then theoretically, one million (100×100×100) different colors can be performed. Practically, only a few colors are enough. That is, colors performed by the full color flashlight of the present invention are no more limited but can be selected from these all colors, therefore, that is a reason to call the invention as full color flashlight.

According to the foregoing, the present invention provides a full color LED flashlight using the high power LED bare chips of different wavelengths. Since these LED bare chips are very small sized and arranged closely, and thus the LED bare chips can exhibit uniform light of purer color similar to a single light source. The photodiffuser can be further added in the transparent glue before the LED bare chips, so that the light beams emitted from the LED chips will travel randomly in arbitrary directions and be mixed well.

The LED flashlight of the present invention also comprises the function switch for changing colors of the light, and/or switching the operation modes such as the fast/slow flash mode, and the un-lighting mode. Since the full color flashlight of the present invention can perform various colors, it is suitable for different situations, for example, the yellow or light blue color is suitable for nighttime to prevent eyes from dazzling, and the red flash may serve as a warning signal during traffic accidents.

According to pervious description, the present invention possesses with commercial benefit, creativity and improvement which are required for applying for a patent. Therefore, it is followed by the law to provide all necessary information.

1. A full color flashlight with high power LEDs, comprising:
a full color LED module, a control-circuit module, a function switch, a battery and a barrel body, said full color LED module, said control-circuit module and said batteries are housed in said barrel body; said control-circuit module has two electrodes connected to electrodes of said battery to form a circuit; wherein
said full color LED module comprises at least two LED chip sets of different wavelengths and a transparent glue having a photodiffuser for covering said LED chip sets of different wavelengths, said LED chip sets of different wavelengths have respective positive and negative electrodes connected to corresponding metallic pin of said full color LED module, and metallic pin are further connected to said control-circuit module; and
said function switch is electrically connected and communicates signals to said control-circuit module which will determine how to light the LED chips.

2-10. (canceled)
